(19) United States
(12) Patent Application Publication
(10) Pub. No.: US 2010/0249447 A1
(43) Pub. Date: Sep. 30, 2010

(54) PURIFICATION OF FULLERENE DERIVATIVES FROM VARIOUS IMPURITIES

(75) Inventors: Thomas A. Lada, Brighton, MA (US); Angela Herring, Jamaica Plain, MA (US); Jennifer Cookson, Boston, MA (US)

Correspondence Address: WILMERHALE/BOSTON, 60 STATE STREET, BOSTON, MA, 02109, US

(73) Assignee: Nano-C, Inc., Westwood, MA (US)

(21) Appl. No.: 12/726,146

(22) Filed: Mar. 17, 2010

Related U.S. Application Data
(60) Provisional application No. 61/160,812, filed on Mar. 17, 2009.

(51) Int. Cl. C07C 69/02

(52) U.S. Cl. 560/129; 977/746; 977/847

(57) ABSTRACT

Purification methods for fullerene derivatives are described. The method comprises passing a solution of fullerene derivatives containing impurities such as other fullerene derivatives and polycyclic aromatic hydrocarbons through activated charcoals. Fullerene derivatives with high purity were obtained.

### RELATED APPLICATIONS

This application claims the benefit of U.S. Provisional Patent Application No. 61/160,812, filed Mar. 17, 2009, which is hereby incorporated by reference in its entirety. All patents, patent applications and publications cited herein are hereby incorporated by reference in their entirety in order to more fully describe the state of the art as known to those skilled therein as of the date of the invention described herein.

### FIELD OF THE INVENTION

This invention relates generally to purification methods for fullerenes and fullerene derivatives. More specifically, the invention relates to purification methods for C₆₀ derivatives, C₇₀ derivatives, other higher fullerene derivatives, or a mixture thereof.

### BACKGROUND OF THE INVENTION

Fullerenes refer to a class of compounds containing carbon cages with a central cavity. Fullerenes and fullerene derivatives have attracted great interests due to their potential applications as lubricants, semiconductors, and superconductors. Commonly used fullerene derivatives include Phenyl-C₆₁-Butyric-Acid-Methyl-Ester (C₆₀PCBM), Thienyl-C₆₁-Butyric-Acid-Methyl-Ester (C₆₀ThCBM), C₆₀-indene adducts (Pupiovskis et al., Tetrahedron Letters, 1997, Vol. 38, No. 2, 285-288; and U.S. Pat. Application No. 2008/0319207), C₆₀-quinodimethane adducts (Belik et al., Angw. Chem. Int. Ed. 1993. 32, No. 1, 78-80), products of modular zwitterions-mediated transformations such as C₆₀-(dimethyl acetylenedicarboxylate) adducts reacted subsequently with a variety of nucleophiles (Zhang et al., J. Am. Chem. Soc. 2007, 129, 7714-7715 and J. Am. Chem. Soc. 2009, 131, 8446-8454), and C₇₀ derivatives. Other examples of common fullerene functionalization schemes are given in the literature such as A. Hirsch and M. Brettreich, Fullerenes Chemistry and Reactions, Wiley-VCH Verlag, 2005, ISBN 3-527-30820-2. Fullerene derivatives are generally more suited for processing than unsubstituted fullerenes while maintaining desirable electronic properties.

C₆₀ is usually produced using a variety of processes such as arc vaporization, laser ablation, and combustion. Along with C₆₀, such processes also produce other fullerene products, such as C₇₀, C₈₄, and other fullerenes, C₁₂₀ and other dimers of fullerenes, and in the case of combustion production, polycyclic aromatic hydrocarbons (PAHs). PAH, also called polyarenes, poly-aromatic hydrocarbons or polynuclear aromatic hydrocarbons consist of fused or otherwise connected aromatic rings. PAH exhibits structural diversity and a significant number of isomers with identical molecular masses has been identified and often synthesized (Polycyclic Aromatic Hydrocarbons, Ronald G. Harvey, Wiley-VCH, New York, 1997, ISBN 0-471-18608-2. Currently, C₆₀ or C₇₀ derivatives are synthesized using a variety of derivatization reactions of C₆₀ or C₇₀. Other fullerenes, dimers, and PAHs are impurities, both in reacted and unreacted forms, when they are mixed with the C₆₀ or C₇₀ present in a reaction mixture. Especially in the combustion method, various types of PAHs containing between 10 and 160 carbon atoms may be generated (Lafleur et al., J. Am. Soc. Mass Spectrom. 1996, 7, 276-286). The chromatographic identification of PAH with 10 to 32 carbon atoms in the condensed material of fullerene-forming flames has been reported (Grieco et al., Proc. Combust. Inst. 1998, 27, 1669-1675) and could result in difficulties during purifications of C₆₀ or C₇₀ derivatives.

A commonly employed method for purifying fullerene derivatives is column chromatography using silica gel as the solid phase. However, this method is sometimes limited in its ability to provide high purity materials.

### SUMMARY

Purification of fullerene derivatives from various impurities is described.

In one aspect of the invention, a method of purifying a fullerene derivative is described. The method including:

introducing a fullerene derivative-impurity mixture onto an activated charcoal column; and

eluting the fullerene derivative using a solvent system to obtain a purified fullerene derivative;

wherein

the fullerene derivative is a derivative of a fullerene or a mixture of derivatives of fullerenes;

the impurity comprises one or more polycyclic aromatic hydrocarbons; and

more than about 25 wt % of the polycyclic aromatic hydrocarbon in the fullerene derivative-impurity mixture is removed after the purification.

In any preceding embodiment, more than about 50 wt % of the polycyclic aromatic hydrocarbon in the fullerene derivative-impurity mixture is removed after the purification.

In any preceding embodiment, more than about 90 wt % of the polycyclic aromatic hydrocarbon in the fullerene derivative-impurity mixture is removed after the purification.

In any preceding embodiment, more than about 95 wt % of the polycyclic aromatic hydrocarbon in the fullerene derivative-impurity mixture is removed after the purification.

In any preceding embodiment, the purity of the fullerene derivative after purification is more than 97%.

In any preceding embodiment, the fullerene derivative-impurity mixture is obtained through derivatization of combustion-based fullerene.

In any preceding embodiment, the polycyclic aromatic hydrocarbon comprises fluorene or pyrene.

In any preceding embodiment, the method further comprises removing the second system from the solution to obtain the fullerene derivative with a high purity.

In any preceding embodiment, the obtained fullerene derivative comprises less than 5% of polycyclic aromatic hydrocarbon.

In any preceding embodiment, the obtained fullerene derivative comprises less than 1% of polycyclic aromatic hydrocarbon.

In any preceding embodiment, the obtained fullerene derivative comprises less than 0.1% of polycyclic aromatic hydrocarbon.

In any preceding embodiment, the obtained fullerene derivative comprises less than 0.01% of polycyclic aromatic hydrocarbon.

In any preceding embodiment, after purification, the mass loss of the fullerene derivative is less than 5%.

In any preceding embodiment, after purification, the mass loss of the fullerene derivative is less than 3%.

In any preceding embodiment, the fullerene derivative-impurity mixture is obtained by passing a reaction mixture of fullerene derivatization through a silica gel column and using a first solvent system to elute the fullerene derivative and removing the first solvent.

In any preceding embodiment, the fullerene derivative comprises a C₆₀ derivative.

In any preceding embodiment, the C₆₀ derivative is at least one C₆₀ derivative selected from the group consisting of C₆₀PCBM, bis-adduct C₆₀PCBM, tris-adduct C₆₀PCBM, tetra-adduct C₆₀PCBM, penta-adduct C₆₀PCBM, hexa-adduct C₆₀PCBM, C₆₀ThCBM, bis-adduct C₆₀ThCBM, tris-adduct C₆₀ThCBM, tetra-adduct C₆₀ThCBM, penta-adduct C₆₀ThCBM, hexa-adduct C₆₀ThCBM, C₆₀ mono-indene adduct, C₆₀ bis-indene adduct, C₆₀ tris-indene adduct, C₆₀ tetra-indene adduct, C₆₀ penta-indene adduct, C₆₀ hexa-indene adduct, C₆₀ mono-quinodimethane adduct, C₆₀ bis-quinodimethane adduct, C₆₀ tris-quinodimethane adduct, C₆₀ tetra-quinodimethane adduct, C₆₀ penta-quinodimethane adduct, C₆₀ hexa-quinodimethane adduct, C₆₀ mono-(dimethyl acetylenedicarboxylate) adduct, C₆₀ bis-(dimethyl acetylenedicarboxylate) adduct, C₆₀ tris-(dimethyl acetylenedicarboxylate) adduct, C₆₀ tetra-(dimethyl acetylenedicarboxylate) adduct, C₆₀ penta-(dimethyl acetylenedicarboxylate) adduct, C₆₀ hexa-(dimethyl acetylenedicarboxylate) adduct, and a mixture thereof.

In any preceding embodiment, the C₆₀ derivative is C₆₀PCBM.

In any preceding embodiment, the solvent system is at least one solvent selected from the group consisting of benzene, toluene, o-dichlorobenzene, o-xylene, other xylenes, chlorobenzene, trimethylbenzene, cyclohexane, naphthalene, methylnaphthalene, chloronaphthalene, any other partially or wholly substituted benzenes, any other partially or wholly substituted naphthalenes, and any combination thereof.

In any preceding embodiment, the second solvent system comprises toluene.

In any preceding embodiment, the activated charcoal is Norit Elorit.

In any preceding embodiment, the C₆₀PCBM is obtained with a purity of more than 97.5%, more than 98.0%, more than 98.5%, more than 99.0%, more than 99.5%, or more than 99.9%.

In any preceding embodiment, the C₆₀PCBM-impurity(ies) mixture is obtained through PCBM derivatization of C₆₀.

In any preceding embodiment, the C₆₀PCBM-impurity(ies) mixture is obtained through PCBM derivatization of combustion-based C₆₀, which is contaminated with polycyclic aromatic hydrocarbons.

In any preceding embodiment, the impurity is at least one impurity selected from the group consisting of TCBM, C₇₀-PCBM derivatives, C₁₂₀-PCBM derivatives, other fullerene-PCBM derivatives, polycyclic aromatic hydrocarbons, and a mixture thereof.

In any preceding embodiment, the polycyclic aromatic hydrocarbon is fluorene or pyrene.

In any preceding embodiment, after purification, the mass loss of C₆₀PCBM is less than 5%.

In any preceding embodiment, after purification, the mass loss of C₆₀PCBM is less than 3%.

In any preceding embodiment, the fullerene derivative is C₇₀ derivative, any higher fullerene derivative, or any combination thereof.

In any preceding embodiment, fullerene derivative is C₇₀ PCBM.

As used herein, “PAH” refers to polycyclic aromatic hydrocarbon, also called polyarenes or polynuclear aromatic hydrocarbons consisting of fused or otherwise connected aromatic rings.

As used herein, “derivatization” refers to a transformation of a molecule, e.g., a fullerene, into a product with a similar structure by modifying the molecule with a functional group. As used herein, “derivative” refers to a product of a derivatization of a molecule, e.g., a fullerene.

As used herein, a “fullerene derivative” refers to a derivative of a fullerene or a mixture of derivatives of fullerenes. A fullerene derivative is a fullerene covalently bonded or otherwise coordinated with one or more atoms or compounds. In some embodiments, a fullerene derivative is a fullerene covalently bonded to one or more hydrocarbon compound. Non-limiting examples of fullerene derivatives include methanofullerene derivatives, PCBM derivatives, ThCBM derivatives, Prato derivatives, Bingel derivatives, diazoline derivatives, azafulleroid derivatives, ketolactam derivatives, and Diels-Alder derivatives. More preferentially, a fullerene derivative is a fullerene bonded to one or more cyclopropyl groups which is in turn bonded to two groups, R₁ and R₂. More preferably, a fullerene derivative is a fullerene comprised of Cₕₒ, C₇₀, C₇₆, C₇₈, or C₈₄ bonded to one or more cyclopropyl groups which is in turn bonded to two groups, R₁ and R₂. R₁ and R₂ groups can be the same or different. Non-limiting examples of R₁ and R₂ include hydrocarbons, hydrogens, and halogens. In some embodiments, R₁ comprises an aromatic compound and R₂ comprises an alkyl group attached to an ester. In some specific embodiments, R₁ is a phenyl group and R₂ is an aliphatic straight-chain butyl group attached at its opposite end to a methyl ester. In some specific embodiments, the fullerene derivative is C₆₀PCBM or C₇₀ PCBM. As used herein, “PCBM” refers to Phenyl-C61-Butyric-acid-Methyl-ester. As used herein, “ThCBM” refers to Thienyl-C61-Butyric-acid-Methyl-ester.

### BRIEF DESCRIPTION OF THE DRAWING

The invention is described with reference to the figures listed below, which are presented for the purpose of illustration only and are not intended to be limiting of the invention.

FIG. 1 is an analytic HPLC trace of C₆₀PCBM before the purification using activated charcoal (Material A).

FIG. 2 is an analytic HPLC trace of C₆₀PCBM collected in flask 1 after the purification using activated charcoal.

FIG. 3 is an analytic HPLC trace of C₆₀PCBM collected in flask 2 after the purification using activated charcoal.

FIG. 4 is an overlay of HPLC traces for samples in Flask 1 and 2 and for Material A.

FIG. 5 is an analytic HPLC trace of C₆₀PCBM after the purification using activated charcoal (C₆₀PCBM in Flask 1 and 2 combined).

FIG. 6 is a comparison of analytic HPLC traces of a C₆₀PCBM sample containing fluorene and pyrene before and after the purification using activated charcoal.

FIG. 7 is a comparison of analytic HPLC traces of a C₆₀ bisPCBM sample before (FIG. 7a) and after (FIG. 7b) the purification using activated charcoal.

### DETAILED DESCRIPTION

An efficient purification method for a fullerene derivative is described. Purification of the fullerene derivative refers to a process of removing a certain amount of impurity which results in an incremental increase of the purity of the fullerene derivative. A fullerene derivative in a first solvent system is introduced to an activated charcoal column and a second solvent system is used to elute the fullerene derivative to obtain an essentially pure second solution of the fullerene derivative. The first solvent system and the second solvent system can be the same or different. In some embodiments, the second solvent is selected to optimize the elution time and resolution of the purification. In some embodiments, the first solvent is selected to minimize the initial loading volume of the fullerene derivative onto the active charcoal in order to maximize resolution of the purification.

Fullerenes can be produced in several methods known in the art. For instance, fullerene can be produced by combustion methods or non-combustion method. Combustion method usually refers to an oxidative decomposition of hydrocarbons. Exemplary methods for combustion production of fullerenes is found in the method described in U.S. Pat. No. 5,273,729 and U.S. Application No. 20080280240. In other instances, fullerenes can be produced by plasma method as well (see L. Fulcheri; N. Probst; G. Flamant; F. Fabry; and E. Grivei Plasma Processing: A Step Towards The Production Of New Grades Of Carbon Black, Third international conference CARBON BLACK MULHOUSE (F) (F) Oct. 25-26, 2000). Fullerenes produced by a method such as combustion usually include certain amounts of PAHs which are difficult to remove. If the fullerene is further derivatized, the PAH impurities will be carried over to the synthesized fullerene derivative. Conventional purification techniques such as HPLC or silica gel column chromatography do not result in satisfactory purity of the fullerene derivative.

Applicants have surprisingly discovered that the use of active charcoal can effectively remove the PAH impurities in the fullerene derivatives. In some embodiments, the purity of the fullerene derivative in the fullerene derivative-impurity mixture after purification increased at least 4% compared with its purity before the purification. In some embodiments, more than about 25 wt % of the polycyclic aromatic hydrocarbon in the fullerene derivative-impurity mixture is removed after the purification. In some embodiments, more than about 50 wt % of the polycyclic aromatic hydrocarbon in the fullerene derivative-impurity mixture is removed after the purification. In some embodiments, more than about 90 wt % of the polycyclic aromatic hydrocarbon in the fullerene derivative-impurity mixture is removed after the purification. In some embodiments, more than about 99 wt % of the polycyclic aromatic hydrocarbon in the fullerene derivative-impurity mixture is removed after the purification. In some embodiments, the weight of the fullerene derivative-impurity mixture remain essentially the same while the polycyclic aromatic hydrocarbon decreases more than two-fold after the purification. In some embodiments, the weight of the fullerene derivative-impurity mixture remains essentially the same while the polycyclic aromatic hydrocarbon decreases more than three-fold after the purification. In some embodiments, the weight of the fullerene derivative-impurity mixture remains essentially the same while the polycyclic aromatic hydrocarbon decreases more than ten-fold after the purification.

The purification method as described herein can be further optimized to improve the efficiency and effectiveness of the purification. In some embodiments, the purification methods described herein can be combined with any method known in the art to further increase the purity of the fullerene derivative. In some embodiments, the amount of the activated charcoal or the length of the activated charcoal column can be adjusted to optimize the performance of the purification.

In some embodiments, after a derivatization reaction, a crude fullerene derivative mixture containing impurity(ies) is first passed through a silica gel column using a first solvent system to obtain a first solution of the fullerene derivative. The first solution is then injected into an activated charcoal column. A second solvent system is then used to elute the fullerene derivative to obtain an essentially pure second solution of the fullerene derivative. The first solvent system and the second solvent system can be the same or different.

In some embodiments, the fullerene derivative is a mixture of derivatives of fullerenes. A mixture of fullerenes and PAHs could be derivatized and processed and the mixture of derivatives of fullerenes is purified by the method using an activated charcoal column as described herein.

In some embodiments, the fullerene derivative is obtained through derivatization of combustion-based fullerene.

In some embodiments, the fullerene derivative after purification using activated charcoal contains less than 5% of PAHs. In some embodiments, the fullerene derivative after purification using activated charcoal contains less than 1% of PAHs. In some embodiments, the fullerene derivative after purification using activated charcoal contains less than 0.1% of PAHs. In some embodiments, the fullerene derivative after purification using activated charcoal contains less than 0.01% of PAHs.

In some embodiments, the PAH impurity contained in the fullerene derivative is pyrene. In some specific embodiments, the fullerene derivative after purification using activated charcoal contains less than 5% of pyrene. In other specific embodiments, the fullerene derivative after purification using activated charcoal contains less than 1% of pyrene. In yet other specific embodiments the fullerene derivative after purification using activated charcoal contains less than 0.1% of pyrene. In yet other specific embodiments the fullerene derivative after purification using activated charcoal contains less than 0.01% of pyrene.

In some embodiments, the PAH impurity contained in the fullerene derivative is fluorene. In some specific embodiments, the fullerene derivative after purification using activated charcoal contains less than 5% of fluorene. In other specific embodiments, the fullerene derivative after purification using activated charcoal contains less than 1% of fluorene. In yet other specific embodiments the fullerene derivative after purification using activated charcoal contains less than 0.1% of fluorene. In yet other specific embodiments the fullerene derivative after purification using activated charcoal contains less than 0.01% of fluorene.

In some embodiments, the purification of fullerene derivative using activated charcoal results in a significant reduction of the percentage of the PAH impurity in the fullerene derivative-PAH mixture without significant loss of the mass of the fullerene derivative. As described herein, in some embodiments, more than about 25 wt % of the polycyclic aromatic hydrocarbon in the fullerene derivative-impurity mixture is removed after the purification. In some embodiments, more than about 50 wt % of the polycyclic aromatic hydrocarbon in the fullerene derivative-impurity mixture is removed after the purification. In some embodiments, more than about 90 wt % of the polycyclic aromatic hydrocarbon in the fullerene derivative-impurity mixture is removed after the purification. In some embodiments, more than about 99 wt % of the polycyclic aromatic hydrocarbon in the fullerene derivative-impurity mixture is removed after the purification. In some embodiments, the weight of the fullerene derivative-impurity mixture remains essentially the same while the polycyclic aromatic hydrocarbon decreases more than two-fold after the purification. In some embodiments, the weight of the fullerene derivative-impurity mixture remains essentially the same while the polycyclic aromatic hydrocarbon decreases more than three-fold after the purification. In some embodiments, the weight of the fullerene derivative-impurity mixture remains essentially the same while the polycyclic aromatic hydrocarbon decreases more than ten-fold after the purification. In some embodiments, the mass loss of the fullerene derivative is less than 5%. In some embodiments, the mass loss of the fullerene derivative is less than 3%.

Derivatization of a fullerene involves the formation of a fullerene covalently bonded or otherwise coordinated with one or more atoms or compounds. Non-limiting examples of derivatization reactions include PCBM derivatization, ThCBM derivatization, methanofullerene derivatization, Prato derivatization, Bingel derivatization, diazoline derivatization, azafulleroid derivatization, ketolactam derivatization, and Diels-derivatization.

The second solvent system is then removed and the fullerene derivative is obtained in high purity. In another embodiment, the fullerene derivative with a purity of >97.5% is obtained. In yet another embodiment, the fullerene derivative with a purity of >98.0% is obtained. In yet another embodiment, the fullerene derivative with a purity of >98.5% is obtained. In yet another embodiment, the fullerene derivative with a purity of >99.0% is obtained. In yet another embodiment, the fullerene derivative with a purity of >99.5% is obtained. In yet another embodiment, the fullerene derivative with a purity of >99.9% is obtained.

The purification method of fullerene derivatives using activated charcoal as described could be applied to small scale as well as large scale purifications. The method as described could be used to efficiently remove other fullerene derivatives as well as PAHs which could be formed during the combustion process to produce fullerenes.

In yet another embodiment, the fullerene derivative is a C₆₀ derivative, a C₇₀ derivative, a higher fullerene derivative, or a mixture thereof.

C₆₀ or C₇₀ could be produced through arc vaporization, laser ablation, or combustion method. In one specific embodiment, C₆₀ or C₇₀ is produced through combustion.

In yet another embodiment, the produced C₆₀ is then subjected to derivatization reactions. Non-limiting examples of the C₆₀ derivatives synthesized include C₆₀PCBM, bis-adduct C₆₀PCBM, tris-adduct C₆₀PCBM, tetra-adduct C₆₀PCBM, penta-adduct C₆₀PCBM, hexa-adduct C₆₀PCBM, C₆₀ThCBM, bis-adduct C₆₀ThCBM, tris-adduct C₆₀ThCBM, tetra-adduct C₆₀ThCBM, penta-adduct C₆₀ThCBM, hexa-adduct C₆₀ThCBM, C₆₀ mono-indene adduct, C₆₀ bis-indene adduct, C₆₀ tris-indene adduct, C₆₀ tetra-indene adduct, C₆₀ penta-indene adduct, C₆₀ hexa-indene adduct, C₆₀ mono-quinodimethane adduct, C₆₀ bis-quinodimethane adduct, C₆₀ tris-quinodimethane adduct, C₆₀ tetra-quinodimethane adduct, C₆₀ penta-quinodimethane adduct, C₆₀ hexa-quinodimethane adduct, C₆₀ mono-(dimethyl acetylenedicarboxylate) adduct, C₆₀ bis-(dimethyl acetylenedicarboxylate) adduct, C₆₀ tris-(dimethyl acetylenedicarboxylate) adduct, C₆₀ tetra-(dimethyl acetylenedicarboxylate) adduct, C₆₀ penta-(dimethyl acetylenedicarboxylate) adduct, and C₆₀ hexa-(dimethyl acetylenedicarboxylate) adduct. In another embodiment, the derivatives are mixtures of fullerene derivatives. In yet another embodiment, the derivatives are mixtures of C₆₀ and C₇₀ derivatives. In yet another embodiment, C₆₀PCBM is synthesized. In yet another embodiment, the produced C₇₀ is then subjected to derivatization reactions. Non-limiting examples of the C₇₀ derivatives synthesized include C₇₀ PCBM or other C₇₀ derivative.

After the derivatization reaction, the crude C₆₀ derivative mixture could contain impurities. Non-limiting examples of impurities include C₆₀, C₇₀, unreacted derivatizing reagents, C₇₀ derivatives, derivatives of fullerene dimers such as C₁₂₀, other fullerene derivatives, and polycyclic aromatic hydrocarbons as well as reaction products of the latter. In one specific embodiment, C₆₀PCBM is synthesized and the crude C₆₀PCBM mixture contains impurities such as tolyl-C₆₁-butyric acid methyl ester (TCBM), C₆₀, C₇₀, C₇₀-PCBM derivatives, C₁₂₀-PCBM derivatives, other fullerene-PCBM derivatives and polycyclic aromatic hydrocarbons such as fluorene or pyrene. Silica gel is the commonly used solid phase for purifying C₆₀PCBM. However many of the aforementioned impurities co-elute with C₆₀PCBM, thereby limiting the final purity achievable through silica gel column chromatography alone.

In one specific embodiment, the essentially pure C₆₀PCBM after purification using activated charcoal has a purity of greater than 98%. In another embodiment, the essentially pure C₆₀PCBM after purification using activated charcoal has a purity of greater than 99%. In yet another embodiment, the essentially pure C₆₀PCBM after purification using activated charcoal has a purity of greater than 99.5%. In yet another embodiment, the essentially pure C₆₀PCBM after purification using activated charcoal has a purity of 99.9%.

In one specific embodiment, the essentially pure C₆₀PCBM after purification using activated charcoal contains less than 0.1% of TCBM. In another embodiment, the essentially pure C₆₀PCBM after purification using activated charcoal contains less than 0.05% of TCBM. In yet another embodiment, the essentially pure C₆₀PCBM after purification using activated charcoal contains less than 0.03% of TCBM. In yet another embodiment, the essentially pure C₆₀PCBM after purification using activated charcoal contains less than 0.025% of TCBM.

In one specific embodiment, the essentially pure C₆₀PCBM after purification using activated charcoal contains less than 0.1% of C₆₀. In another embodiment, the essentially pure C₆₀PCBM after purification using activated charcoal contains less than 0.05% of C₆₀. In yet another embodiment, the essentially pure C₆₀PCBM after purification using activated charcoal contains less than 0.02% of C₆₀. In yet another embodiment, the essentially pure C₆₀PCBM after purification using activated charcoal contains less than 0.015% of C₆₀.

In one specific embodiment, the essentially pure C₆₀PCBM after purification using activated charcoal contains less than 0.1% of C₇₀. In another embodiment, the essentially pure C₆₀PCBM after purification using activated charcoal contains less than 0.05% of C₇₀. In yet another embodiment, the essentially pure C₆₀PCBM after purification using activated charcoal contains less than 0.02% of C₇₀.

In one specific embodiment, the essentially pure C₆₀PCBM after purification using activated charcoal contains less than 0.5% of any or all C₁₂₀PCBM isomers. In another embodiment, the essentially pure C₆₀PCBM after purification using activated charcoal contains less than 0.1% of any or all C₁₂₀PCBM isomers. In yet another embodiment, the essentially pure C₆₀PCBM after purification using activated charcoal contains less than 0.05% of any or all C₁₂₀PCBM isomers. In yet another embodiment, the concentration of any or all C₁₂₀PCBM isomers in the essentially pure C₆₀PCBM is below the level of detection limit of an instrument such as HPLC.

In one specific embodiment, the essentially pure C₆₀PCBM after purification using activated charcoal contains less than 0.005% of C₇₀PCBM. In another embodiment, the concentration of C₇₀PCBM in the essentially pure C₆₀PCBM is below the level of detection limit of an instrument such as HPLC.

In one specific embodiment, C₆₀PCBM after purification using activated charcoal contains less than 5% of PAHs. In another embodiment, the essentially pure C₆₀PCBM after purification using activated charcoal contains less than 1% of PAHs. In yet another embodiment, the essentially pure C₆₀PCBM after purification using activated charcoal contains less than 0.1% of PAHs. In yet another embodiment, the essentially pure C₆₀PCBM after purification using activated charcoal contains less than 0.01% of PAHs.

In one specific embodiment, C₆₀PCBM after purification using activated charcoal contains less than 5% of pyrene. In another embodiment, C₆₀PCBM after purification using activated charcoal contains less than 1% of pyrene. In yet another embodiment, C₆₀PCBM after purification using activated charcoal contains less than 0.1% of pyrene. In yet another embodiment, C₆₀PCBM after purification using activated charcoal contains less than 0.01% of pyrene.

In one specific embodiment, C₆₀PCBM after purification using activated charcoal contains less than 5% of fluorene. In another embodiment, C₆₀PCBM after purification using activated charcoal contains less than 1% of fluorene. In yet another embodiment, C₆₀PCBM after purification using activated charcoal contains less than 0.1% of fluorene. In yet another embodiment, C₆₀PCBM after purification using activated charcoal contains less than 0.01% of fluorene.

Silica gel of various types, brand, and mesh sizes could be used in the purification of C₆₀ derivatives. In one specific embodiment, silica gel (230-400 mesh) is used in the purification of C₆₀ derivatives.

Any polar or non-polar activated charcoal could be used for the purification of C₆₀ derivatives. In one specific embodiment, Norit Elorit activated charcoal is used for the purification of C₆₀ derivatives. Other examples of activated charcoal include Norit A activated charcoal.

The first and second solvent systems used for eluting the fullerene derivative through the activated charcoal could be benzene, toluene, o-dichlorobenzene, o-xylene, other xylenes, chlorobenzene, trimethylbenzenes (specific isomers or their mixtures), cyclohexane, naphthalene, methylnaphthalenes (specific isomers or their mixtures), chloronaphthalenes (specific isomers or their mixtures), any other partially or wholly substituted benzenes, any other partially or wholly substituted naphthalenes, or a combination thereof. In one specific embodiment, toluene is used as the second solvent for eluting the C₆₀ derivative through the activated charcoal. In another specific embodiment, toluene is used as the first for eluting the C₆₀ derivative through the silica gel column. In yet another embodiment, a second solvent system is selected from the group comprising toluene, o-xylene, p-xylene (or a mixture between o- and p-xylene), chlorobenzene, and any combination thereof to elute C₇₀ derivative from the activated charcoal column.

GC, HPLC, or any other analytical method known in the art could be used to determine the purity of C₆₀ or C₇₀ derivative samples. In one specific embodiment, HPLC is used to determine the purity of C₆₀ or C₇₀ derivative samples.

### General Experimental Information

C₆₀ was produced by non-combustion method or combustion method according to the method described in U.S. Pat. No. 5,273,729 and U.S. Application No. 20080280240. HPLC analysis was conducted using Agilent 1100 Series HPLC with a Buckyprep column. Toluene was purchased from Houghton Chemical and used without further purification. Silica gel (230-400 mesh) was purchased from Alfa Aesar. Norit Elorit activated charcoal was purchased from Norit.

### Example 1

### Synthesis and Purification of C₆₀PCBM

Using C₆₀ obtained from non-combustion methods as starting material, the synthesis of C₆₀PCBM derivative was performed according to methods described in 1). Hummelen et al. J. Org. Chem. 1995, 60, 532; 2). Wienk et al., Angew. Chem. Int. Ed. 2003, 42, 3371-3375; or 3). Kooistra et al, Chem. Mater. 2006, 18, 3068-3073; with modifications.

The reaction mixture containing C₆₀PCBM was purified first using a silica gel column as described below.

The reaction mixture was filtered using vacuum filtration to separate soluble reaction mixture from insoluble salts using VWR size 410 filter paper (1 μm pore size). The soluble mixture containing C₆₀PCBM was passed through a silica gel column (750 g, 230-400 mesh) and using o-dichlorobenzene as eluent to elute out the C₆₀ band. Toluene was then used to elute the C₆₀PCBM band, which emerged directly after the C₆₀ band. 1 L toluene samples of C₆₀PCBM were collected and their purities were analyzed by HPLC. The toluene samples of C₆₀PCBM with high purities were then combined as Material A (3 Liters).

C₆₀PCBM was then further purified using Norit Elorit activated charcoal.

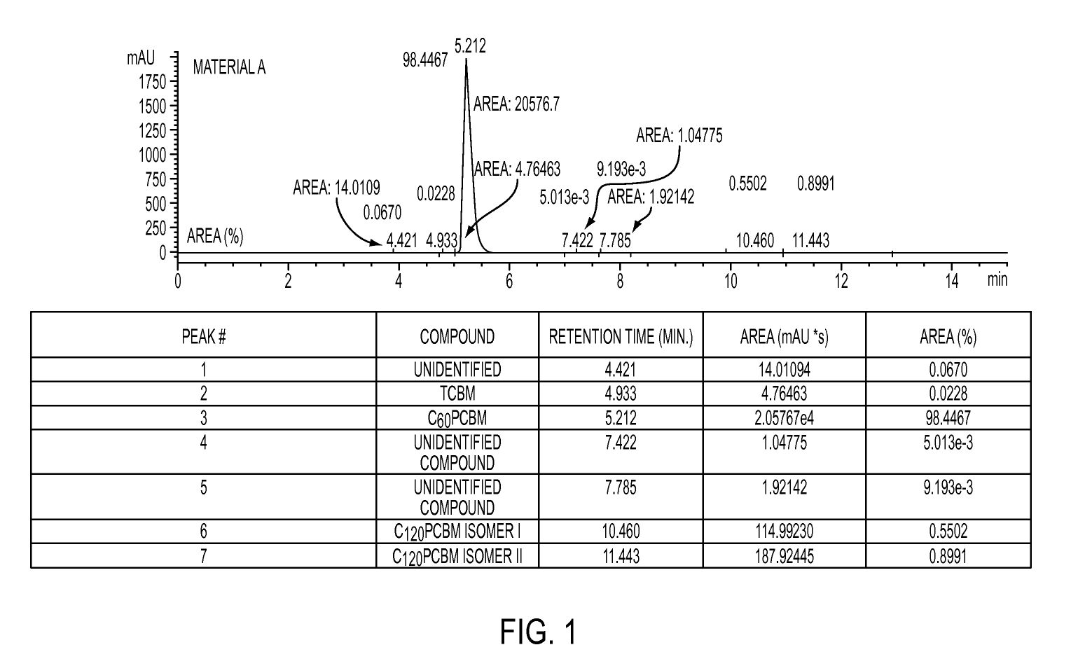

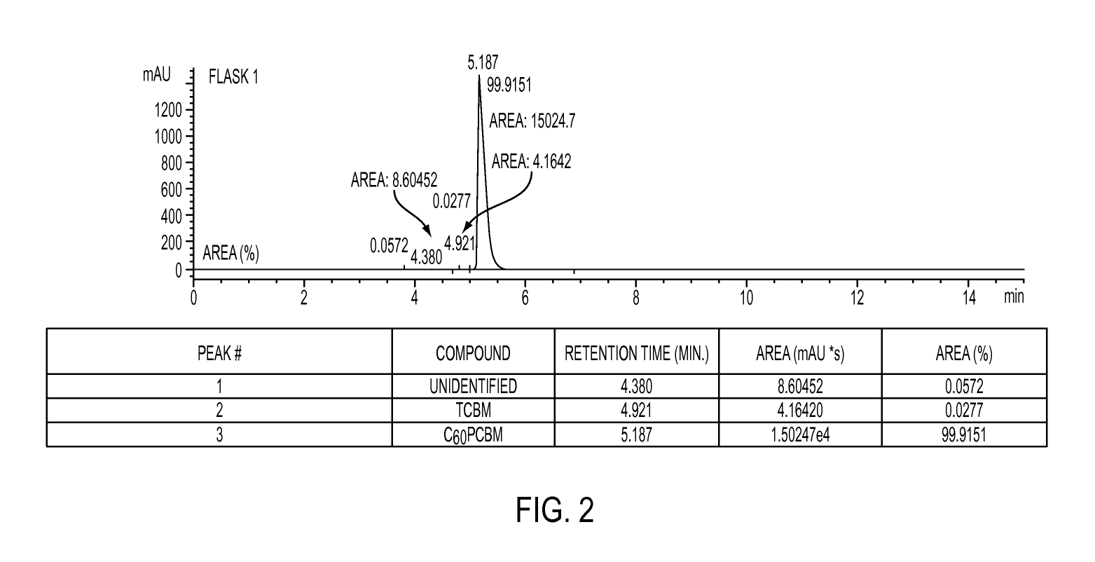

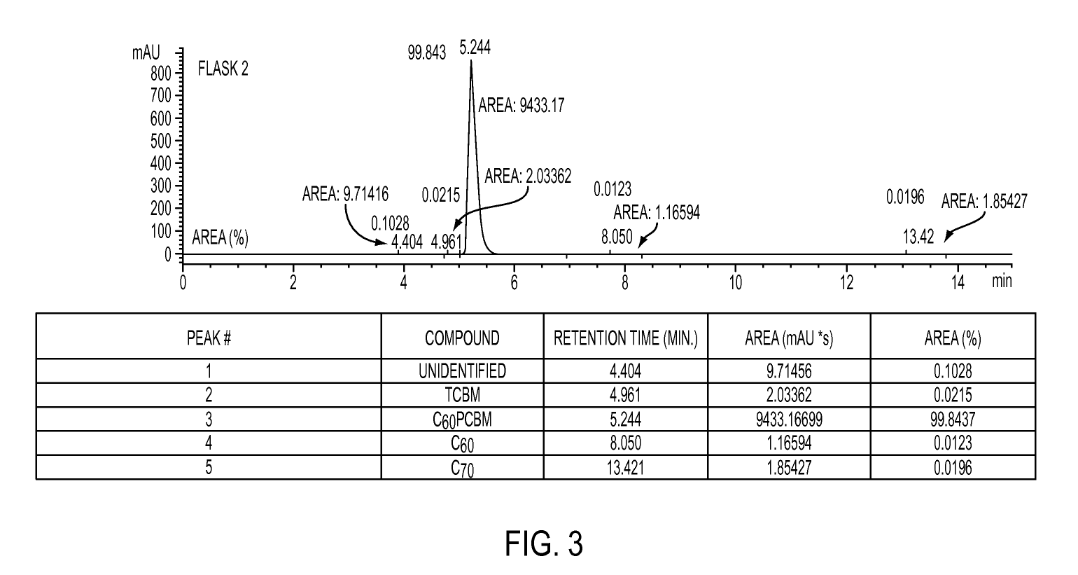

The purity of Material A was analyzed by HPLC and the HPLC trace is shown in FIG. 1. As FIG. 1 indicates, the purity of C₆₀PCBM is 98.45%, with various impurities such as TCBM, unidentified but undesired compounds, a mixture of C₁₂₀PCBM isomers. Initial experiments indicated that a better separation of C₆₀PCBM from its impurities was obtained when the crude solution was more concentrated. The volume of Material A was thus reduced from 3 L to approximately 500 mL using rotary evaporation. A single injection of Material A was made onto 45 g Norit Elorit (activated charcoal) packed in toluene in a f-inch glass column. When all material had successfully entered the charcoal column, the product of interest (C₆₀PCBM) was eluted with toluene. Sample collection began when a noticeable color change or darkening of the eluting liquid was observed. Samples were collected in 1-Liter Erlenmeyer flasks until associated calculations from the HPLC analyses of the collected material indicated a negligible concentration. From the injection of Material A, two samples were collected labeled as Flask 1 (1000 mL) and Flask 2 (650 mL). Their purities were analyzed by HPLC and the HPLC traces are shown in FIG. 2 and FIG. 3, respectively. HPLC traces indicated that the sample in Flask 1 contains C₆₀PCBM with a purity of 99.92% (FIG. 2), and that the sample in Flask 2 contains C₆₀PCBM with a purity of 99.84% (FIG. 3).

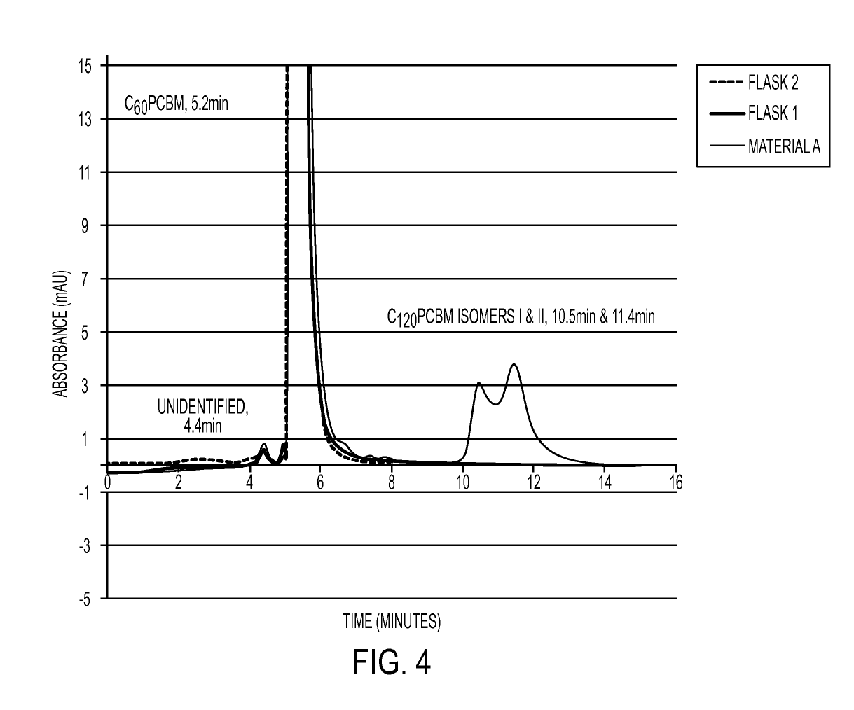

The use of charcoal successfully separated C₆₀PCBM from impurities (peaks with elution times of 10.5 and 11.4 minutes in FIG. 1) and further did not result in a significant loss in mass of C₆₀PCBM. FIG. 4 shows an overlay of HPLC traces for samples in Flask 1 and 2 and for Material A. As FIG. 4 demonstrates, C₁₂₀PCBM isomers I and II, which were present in Material A, were successfully removed by using activated charcoal.

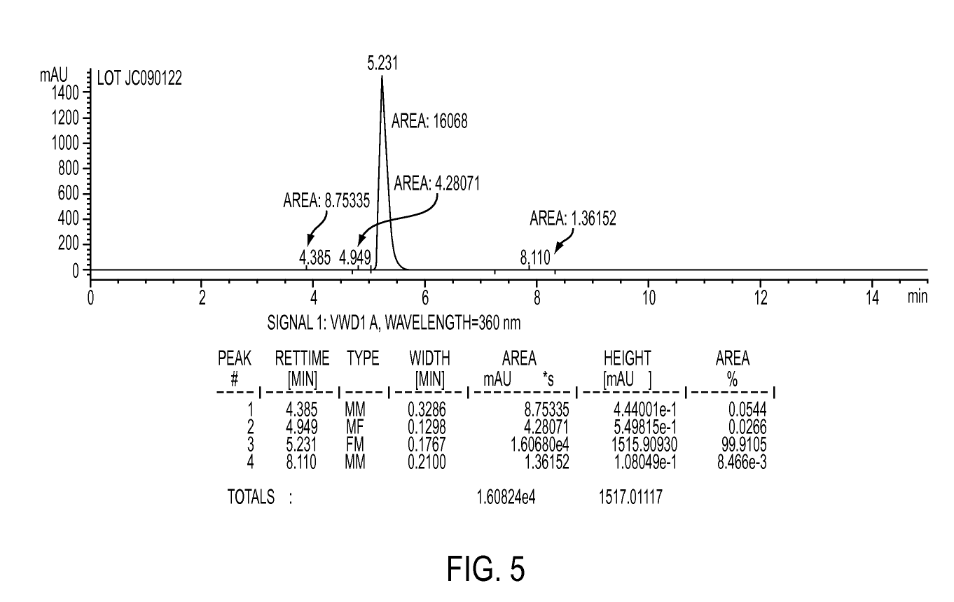

The samples in Flasks 1 and 2 were then combined and toluene was removed by rotary evaporation to afford crystals which were further processed. 7.88 g of C₆₀PCBM was obtained (Lot JC090122). The purity of C₆₀PCBM in this material (Lot JC090122) was analyzed by HPLC (FIG. 5) to be 99.91%.

### Example 2

### Removing Combustion Based Impurities from C₆₀PCBM Using Activated Charcoal

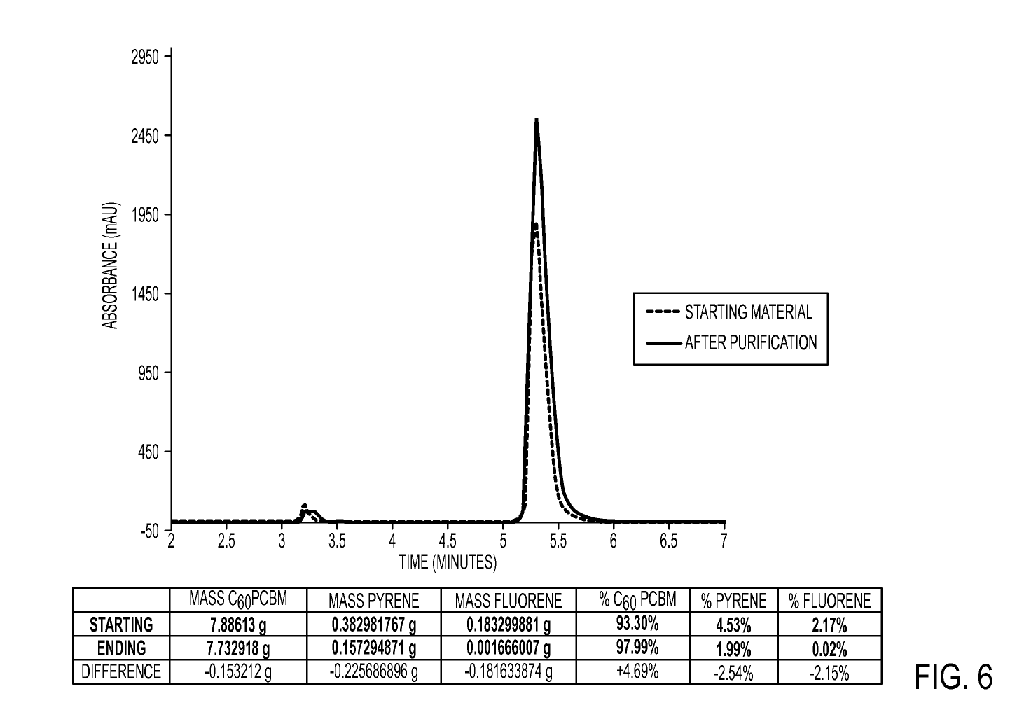

Polycyclic aromatic hydrocarbons (PAHs) are generally produced during the production of C₆₀ through combustion method and could still be present after the derivatization reaction of C₆₀ with PCBM. In order to demonstrate the efficiency of the activated charcoal method in removing the PAH impurities, an essentially pure sample of C₆₀PCBM (7.52 g) was mixed with fluorene (0.235 g) and pyrene (0.251 g) (both fluorene and pyrene are PAHs found in combustion based fullerene material). Toluene (800 mL) was added to the solid mixture and the resulting mixture was stirred overnight to dissolve the solid material. 45 g Norit Elorit (activated charcoal) was packed into a 1-inch diameter glass column using toluene. The 800 mL solution of the C₆₀PCBM mixture with PAHs was injected onto the Norit Elorit column and the column was eluted with toluene. 5 cuts were taken and analyzed with HPLC at both 290 nm and 360 nm. FIG. 6 shows an overlay of HPLC traces of the C₆₀PCBM samples before and after the purification using activated charcoal. The fluorene and pyrene peaks (the partially overlapping peaks between 3 min and 3.5 min) showed reduced absorbance on the HPLC trace after the purification using activated charcoal. As FIG. 6 shows, passing a C₆₀PCBM sample contaminated with PAHs over activated charcoal resulted in a significant reduction of PAH contents without significant lost of mass of C₆₀PCBM. Thus, the loss of mass of C₆₀PCBM was 2.9%. The purity of C₆₀PCBM was improved from 93.30% to 97.99% by the purification using activated charcoal. The percentage of pyrene contained in the C₆₀PCBM sample was reduced from 4.53% to 1.99%. The percentage of fluorene contained in the C₆₀PCBM sample was reduced from 2.17% to 0.02%. FIG. 6 shows that activated charcoal could be used to efficiently remove PAHs commonly found in combustion-based fullerenessuch as pyrene or fluorene to obtain highly pure C₆₀PCBM.

### Example 3

### Removing Combustion Based Impurities from C₆₀ bis-PCBM Using Activated Charcoal

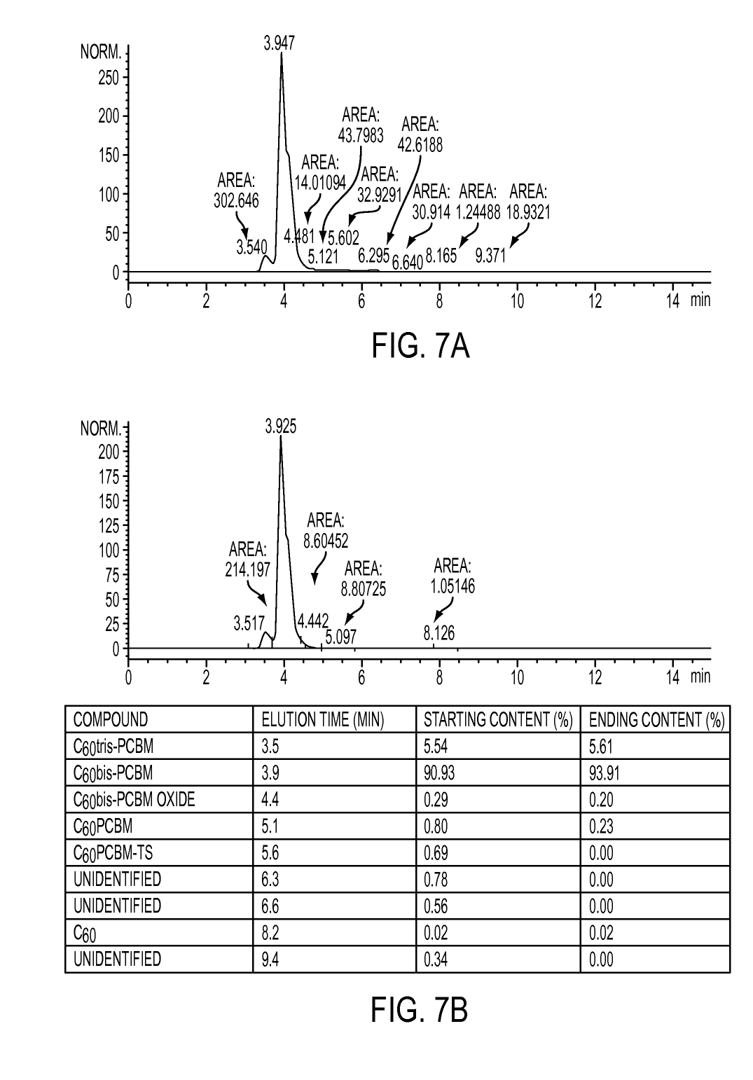

2 L of a 14.8 g/L solution of C₆₀bis-PCBM in toluene (see FIG. 7a) was injected onto a 300 g Norit Elorit column (3-inch diameter). Toluene was used to elute the material and one 6 L cut was obtained (see FIG. 7b). C₆₀ bis-PCBM oxide was reduced from 0.29% to 0.20%; C₆₀PCBM was reduced from 0.80% to 0.23%; the tosylate of PCBM (C₆₀PCBM-TS) was reduced from 0.69% to 0.00%. Two unidentified but undesired compounds eluting at 6.3 minutes and 6.6 minutes were reduced from 0.78% and 0.56% (respectively) to 0.00%. C₆₀ content remained the same at 0.02%. An unidentified but undesired compound eluting at 9.4 minutes was reduced from 0.34% to 0.00%. The overall purity of the C₆₀ bis-PCBM was increased from 90.93% to 93.91%.

The foregoing illustrates specific embodiments of this invention. Other modifications and variations of the invention will be readily apparent to those of skill in the art in view of the teaching presented herein. The foregoing is intended as an illustration, but not a limitation, upon the practice of the invention. It is the following claims, including all equivalents, which define the scope of the invention.

What is claimed is:

1. A method of purifying a fullerene derivative, comprising
introducing a fullerene derivative-impurity mixture onto an activated charcoal column; and
eluting said fullerene derivative using a solvent system to obtain a purified said fullerene derivative;
wherein
said fullerene derivative is a derivative of a fullerene or a mixture of derivatives of fullerenes;
said impurity comprises one or more polycyclic aromatic hydrocarbons; and
more than about 25 wt % of the polycyclic aromatic hydrocarbon in the fullerene derivative-impurity mixture is removed after the purification.

2. The method of claim 1, wherein more than about 50 wt % of the polycyclic aromatic hydrocarbon in the fullerene derivative-impurity mixture is removed after the purification.

3. The method of claim 1, wherein more than about 90 wt % of the polycyclic aromatic hydrocarbon in the fullerene derivative-impurity mixture is removed after the purification.

4. The method of claim 1, wherein more than about 95 wt % of the polycyclic aromatic hydrocarbon in the fullerene derivative-impurity mixture is removed after the purification.

5. The method of claim 1, wherein the purity of the fullerene derivative after purification is more than 97%.

6. The method of claim 1, wherein the fullerene derivative-impurity mixture is obtained through derivatization of combustion-based fullerene.

7. The method of claim 1, wherein said polycyclic aromatic hydrocarbon comprises fluorene or pyrene.

8. The method of claim 1 or 6, further comprising removing said second system from said solution to obtain said fullerene derivative with a high purity.

9. The method of claim 8, wherein said obtained fullerene derivative comprises less than 5% of polycyclic aromatic hydrocarbon.

10. The method of claim 8, wherein said obtained fullerene derivative comprises less than 1% of polycyclic aromatic hydrocarbon.

11. The method of claim 8, wherein said obtained fullerene derivative comprises less than 0.1% of polycyclic aromatic hydrocarbon.

12. The method of claim 8, wherein said obtained fullerene derivative comprises less than 0.01% of polycyclic aromatic hydrocarbon.

13. The method of claim 8, wherein after purification, the mass loss of the fullerene derivative is less than 5%.

14. The method of claim 8, wherein after purification, the mass loss of the fullerene derivative is less than 3%.

15. The method of claim 1, wherein said fullerene derivative-impurity mixture is obtained by passing a reaction mixture of fullerene derivatization through a silica gel column and using a first solvent system to elute said fullerene derivative and removing the first solvent.

16. The method of claim 1, wherein said fullerene derivative comprises a C₆₀ derivative.

17. The method of claim 16, wherein said C₆₀ derivative is at least one C₆₀ derivative selected from the group consisting of C₆₀PCBM, bis-adduct C₆₀PCBM, tris-adduct C₆₀PCBM, tetra-adduct C₆₀PCBM, penta-adduct C₆₀PCBM, hexa-adduct C₆₀PCBM, C₆₀ThCBM, bis-adduct C₆₀ThCBM, tris-adduct C₆₀ThCBM, tetra-adduct C₆₀ThCBM, penta-adduct C₆₀ThCBM, hexa-adduct C₆₀ThCBM, C₆₀ mono-indene adduct, C₆₀ bis-indene adduct, C₆₀ tris-indene adduct, C₆₀ tetra-indene adduct, C₆₀ penta-indene adduct, C₆₀ hexa-indene adduct, C₆₀ mono-quinodimethane adduct, C₆₀ bis-quinodimethane adduct, C₆₀ tris-quinodimethane adduct, C₆₀ tetra-quinodimethane adduct, C₆₀ penta-quinodimethane adduct, C₆₀ hexa-quinodimethane adduct, C₆₀ mono-(dimethyl acetylenedicarboxylate) adduct, C₆₀ bis-(dimethyl acetylenedicarboxylate) adduct, C₆₀ tris-(dimethyl acetylenedicarboxylate) adduct, C₆₀ tetra-(dimethyl acetylenedicarboxylate) adduct, C₆₀ penta-(dimethyl acetylenedicarboxylate) adduct, C₆₀ hexa-(dimethyl acetylenedicarboxylate) adduct, and a mixture thereof.

18. The method of claim 17, wherein said C₆₀ derivative is C₆₀PCBM.

19. The method of claim 1, wherein said solvent system is at least one solvent selected form the group consisting of benzene, toluene, o-dichlorobenzene, o-xylene, other xylenes, chlorobenzene, trimethylbenzene, cyclohexane, naphthalene, methylnaphthalene, chloronaphthalene, any other partially or wholly substituted benzenes, any other partially or wholly substituted naphthalenes, and any combination thereof.

20. The method of claim 19, wherein said second solvent system comprises toluene.

21. The method of claim 1, wherein said activated charcoal is Norit Elorit.

22. The method of claim 18, wherein said C₆₀PCBM is obtained with a purity of more than 97.5%, more than 98.0%, more than 98.5%, more than 99.0%, more than 99.5%, or more than 99.9%.

23. The method of claim 18, wherein said C₆₀PCBM-impurity(ies) mixture is obtained through PCBM derivatization of C₆₀.

24. The method of claim 18, wherein said C₆₀PCBM-impurity(ies) mixture is obtained through PCBM derivatization of combustion-based C₆₀, which is contaminated with polycyclic aromatic hydrocarbons.

25. The method of claim 23, wherein said impurity is at least one impurity selected from the group consisting of TCBM, C₇₀-PCBM derivatives, C₁₂₀-PCBM derivatives, other fullerene-PCBM derivatives, polycyclic aromatic hydrocarbons, and a mixture thereof.

26. The method of claim 25, wherein said polycyclic aromatic hydrocarbon is fluorene or pyrene.

27. The method of claim 18, wherein after purification, the mass loss of C₆₀PCBM is less than 5%.

28. The method of claim 18, wherein after purification, the mass loss of C₆₀PCBM is less than 3%.

29. The method of claim 1, wherein said fullerene derivative is C₇₀ derivative, any higher fullerene derivative, or any combination thereof.

30. The method of claim 1, wherein said fullerene derivative is C₇₀ PCBM.
